(19) United States
(12) Patent Application Publication
(10) Pub. No.: US 2014/0025219 A1
(43) Pub. Date: Jan. 23, 2014

(54) HOME ENERGY MANAGEMENT SYSTEM WITH SABBATH COMPLIANT FUNCTIONALITY

(71) Applicants: Jay Andrew Broniak, Louisville, KY (US); Robert Marten Bultman, Louisville, KY (US); William Anthony Watts, Chicago, IL (US)

(72) Inventors: Jay Andrew Broniak, Louisville, KY (US); Robert Marten Bultman, Louisville, KY (US); William Anthony Watts, Chicago, IL (US)

(21) Appl. No.: 13/551,960

(22) Filed: Jul. 18, 2012

(51) Int. Cl. G06F 1/26

(52) U.S. Cl. 700/296

(57) ABSTRACT

A home energy management system simplifies the process of enabling and executing the Sabbath mode and similar operating modes on household devices. A central location, or central node device, is provided which enables the end user to selectively modify operation of the household devices, e.g., from a normal operating mode to the Sabbath mode.

### BACKGROUND OF THE INVENTION

The subject matter disclosed herein relates to home energy management (HEM) systems and, in particular, to features of home energy management systems that manage operation of household devices (e.g., appliances, light fixtures, etc.) to conform with religious observances.

Some religious observances do not permit practitioners to actuate or to cause changes to the status of devices found in their household. Orthodox Jewish customs, for example, forbid work to be done on the Sabbath. This prohibition even extends to actions that cause devices to change their normal pattern of operation, e.g., an action by an end user that results in illumination of a display.

Household devices (e.g., stoves and refrigerators) are known with operating modes that conform operation of the device to these customs. Examples of these devices come equipped with a Sabbath mode or process, which selectively deactivates and/or delays operation of functions on the household device. Use of the Sabbath mode allows the end user to freely continue use of the household device without fear of running afoul of customs of their faith.

Although these features are available, the end user that wishes to implement the Sabbath mode can face a number of obstacles. Often, the end user must undertake a process to utilize the Sabbath method that is different for each household device and across the range of household devices the end user may have in their home. For example, access to enable the Sabbath mode features may differ between a stove and a refrigerator. Moreover, because the features of the Sabbath mode are used by only a small subset of end users, Sabbath-mode ready household devices often require the end user to enter a complicated combination of keystrokes and/or button presses/holds to change the household device from normal operating mode to the Sabbath mode.

### BRIEF DESCRIPTION OF THE INVENTION

This disclosure provides, in one embodiment, a home energy management system that comprises a household device and a central node device remotely located from the household device and that is configured to exchange a signal with the household device. The central node comprises a processor, memory, and executable instructions stored on the memory and configured to be executed by the processor. The one or more executable instructions comprising executable instructions for generating the signal, wherein the signal encodes a selected configuration for operation of the household device in a Sabbath mode.

This disclosure also provides, in one embodiment, a method of controlling operation of a household device. The method comprises, at a central node device comprising a processor and memory receiving an input, a step for generating a signal and in response to the input, the method comprises a step that changes operation of the household device from a first mode to a second mode, wherein the second mode instructs operation of one or more functions of the household device in accordance with observation of the Sabbath.

This disclosure further provides, in one embodiment, a central node device for use in a home energy management system. The central node device comprises a processor, memory coupled to the processor, and one or more executable instructions stored on the memory and configured to be executed by the processor. The one or more executable instructions comprise executable instructions for identifying from an input a selected configuration for a Sabbath mode on a household device. The executable instructions also comprise executable instructions for generating a signal that encodes the selected configuration for operation of the household device.

This brief description of the invention is intended only to provide a brief overview of the subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 depicts a schematic diagram of an exemplary energy management system;

FIG. 2 depicts a flow diagram of an exemplary method for operating a household device;

FIG. 3 depicts a schematic diagram of a graphical user interface;

FIG. 4 depicts a screen show of one example of the graphical user interface of FIG. 3; and

FIG. 5 depicts a schematic diagram of a high-level wiring schematic of a central node device for use in the energy management system of FIG. 1.

### DETAILED DESCRIPTION OF THE PREFERRED EMBODIMENTS OF THE INVENTION

This disclosure describes embodiments of a home energy management system that simplifies the process to enable and execute the Sabbath mode and similar operating modes on household devices. As discussed more below, these embodiments provide a central location, or central node device, at which the end user can selectively modify operation of the household devices, e.g., from a normal operating mode to the Sabbath mode.

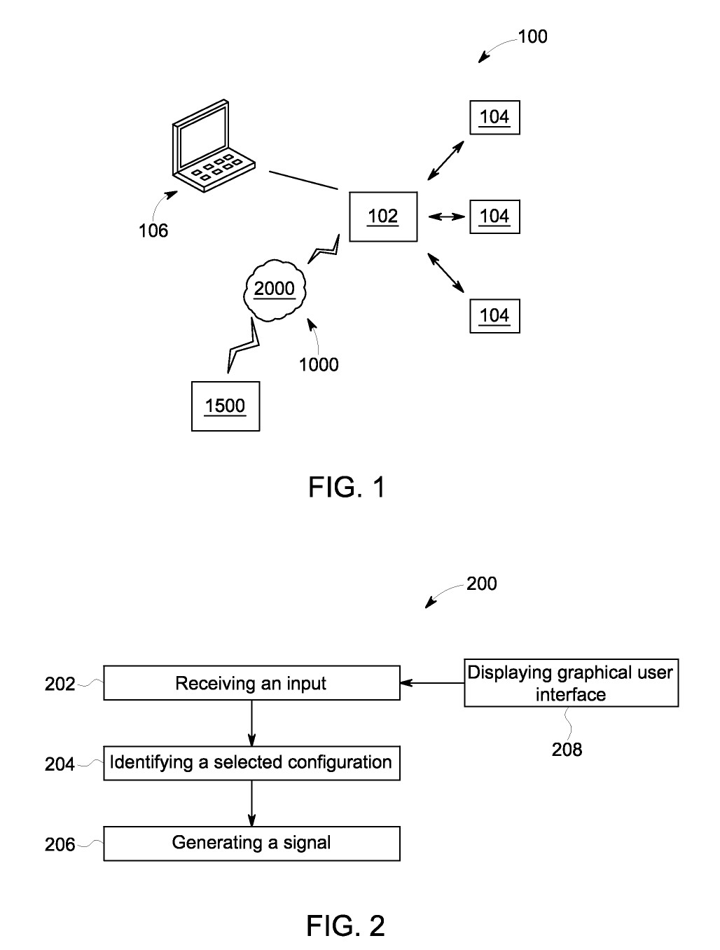

FIG. 1 illustrates one embodiment of an energy management system 100 (also “system 100”) that can manage operation of devices in a household. The system 100 includes a central node device 102 remotely located from one or more household devices 104. The central node device 102 may communicate with a network system 1000, which has one or more external devices 1500 (e.g., an external server) coupled via a network 2000. An end user can communicate with the network system 1000, as well as the central node device 102, with a computing device 106. Examples of the computing device 106 include computers (e.g., a laptop computer) and/or one or more mobile devices (e.g., a PDA, smartphone, a tablet, etc.).

Examples of the household devices 104 include sophisticated and unsophisticated items found throughout a household. Some of these items come equipped with components necessary to implement features and functions of a Sabbath mode. For example, household appliances (e.g., refrigerators, stoves, dishwashers, clothes dryers, etc.) can have circuitry operative to store and execute software instructions that modify operation, e.g., of lights and displays to conform with the Sabbath custom. On the other hand, light fixtures, clocks, and like items may have less intuitive features. These items may be devoid of the elements necessary to operate in the Sabbath mode.

As discussed more below, examples of the energy management system 100 can facilitate operation of both sophisticated and unsophisticated devices to conform operation to the Sabbath custom. For sophisticated devices, e.g., home appliances, for example, the energy management system 100 provides an end user a central location (e.g., the central node device 102) from which to instruct one or more of the household devices 104 to operate in the Sabbath mode. This feature centralizes control of the various household devices 104, thereby simplifying the process for the end user to ensure compliance with the Sabbath custom. Moreover, in one embodiment, the energy management system 100 further utilizes the central node device 102 to operate the less-sophisticated devices in accordance with the Sabbath mode. This feature offers the benefits of the sophisticated operation of the Sabbath mode-equipped appliances on devices not normally equipped for such operation.

The central node device 102 can communicate, either directly or indirectly, with the household devices 104 to exchange signals. Examples of the central node device 102 and the household devices 104 can accommodate wired communication (e.g., via Ethernet connection, RS-232 connection, USB connection, and the like) and wireless connections (e.g., Bluetooth, 802.11 WiFi, FM RDS devices, 802.15.4 compliant ZigBee). The signals can encode information, data, and other content. In one embodiment, the signals encode a selected configuration for the Sabbath mode. This selected configuration identifies how the household device 104 is to implement the Sabbath mode. For example, the selected configuration can instruct one or more of the household devices 104 to enable the Sabbath mode. The selected configuration can, in another example, instruct one or more of the household devices 104 to disable the

Sabbath mode.

The selected configuration can also prescribe certain operating characteristics for the household devices 104 that relate to implementation of the Sabbath mode. These operating characteristics can, for example, cause the household devices 104 to delay enablement of the Sabbath mode for a prescribed time period, e.g., for a certain number of hours after the signals are received by the household devices 104. In other examples, the prescribed time period can delay transmission of signals from the central control node 102 to the household device 104. The delay of these signals can, in turn, delay implementation of the Sabbath mode. In other examples, the operating characteristics can cause the household devices 104 to enable the Sabbath mode in accordance with a calendar entry that may correspond to dates and/or days of the year (e.g., holidays, weekends, etc.).

Examples of the central node device 102 can also display a graphical user interface (GUI), which can resolve on a display that is part of construction of the central node device 102 or separately located, e.g., on the computing device 106. The GUI can present information to the end user that relates to operation of the Sabbath mode on the household devices 104. Such information can indicate the status of the Sabbath mode, either as enabled and/or disabled, active and/or inactive, and the like. In one example, the GUI can solicit one or more inputs from the end user. These inputs can take the form of keystrokes (e.g., on a keyboard or touch screen) and/or selectable icon or implement that the end user engages, e.g., by clicking with a stylus or finger. Examples of the inputs can indicated the selected configuration that the end user desires for the Sabbath mode on the household device 104.

FIG. 2 illustrates a flow diagram for a method 200 of controlling operation of household device to implement a Sabbath mode. The method 200 includes, at step 202, receiving an input and, at step 204, identifying a selected configuration from the input. The method 200 can also include, at step 206, generating a signal. In one embodiment, the method 200 also includes, at step 208, displaying a graphical user interface.

Collectively, one or more of the steps of the method 200 can be coded as one or more executable instructions (e.g., hardware, firmware, software, software programs). Examples of a central node device (e.g., central node device 102 of FIG. 1) can execute these executable instruction to cause certain changes in operation of the household device. These changes include, for example, changes in operating state, e.g., from a first state of operation to a second state of operation.

Receiving the input (e.g., at step 204) can occur by way of end user interaction with a central node device (e.g., central node device 102 of FIG. 1) and/or by way of automated delivery of information thereto. As discussed above, the end user can use a computer or mobile device to generate the input that the central node device receives. In other embodiments, the central node device may receive the input in the form of an electronic message (e.g., email, text message, etc.) or other signals from a utility or other external service or device. The electronic message could, for example, arise from an automated service that maintains a calendar of the important days on which household devices (e.g., household devices 104 of FIG. 1) should operate in the Sabbath mode. In one embodiment, the central node device can proactively retrieve the input, e.g., from a repository (e.g., external server 1500 of FIG. 1) or other Internet-based and/or cloud-based location. For such retrieval processes, for example, the central node device may access an on-line resource that maintains the calendar days as well as other on-line and remote resources that can store information that can set the selected configuration as contemplated herein.

Identifying the selected configuration (e.g., at step 204) from the input can associate information from the input with other information that relates to the selected configuration. This process may include use of a look-up table and/or other database that establishes the relationship between the input and options for the selected configuration. Likewise, for downloaded and/or retrieved information, examples of the central node device can parse, filter, decode, and manipulate the information to extract the relevant information necessary to identify the selected configuration therein.

Generating the signal (e.g., at step 206) can form the signal to convey the selected configuration (and other information) to the household devices in a variety of ways. The resulting signal can, for example, simply comprise a binary representation of the selected configuration, e.g., a high or low voltage, a zero or one, etc. In other examples, the resulting signal can form a data packet, which includes more detailed information to define the selected configuration as well as other information that can influence operation of the household device. For example, the data packet can include a data key, which designates the target (e.g., a particular household device). The data key can permit the central control node to broadcast a plurality of data packets, one for each of the household devices in the energy management system, or a single data packet, which may include multiple different data keys and multiple different selected configurations. The household devices can receive the single data packet, identify the appropriate data key, and thereafter utilize the selected configuration that relates to the particular data key.

Generally, the data packet can encode the information using a variety of encoding schemes. Exemplary schemes can use numeric, alphabetic, and alphanumeric coding such as binary and ASCII coding. The present disclosure likewise considers more complex encoding, which can provide more secure communication of information if necessary between the central node device and the household devices and, generally, about the energy management system (e.g., energy management system 100 of FIG. 1) and the network system (e.g., network system 1000 of FIG. 1).

In one embodiment, the signal and/or data packet can comprise information that operates the household device as though the household device has entered the Sabbath mode. This feature can, for example, selectively energize lights and light bulbs, deactivate alarms, dim displays, and perform other tasks that conform the observation of the Sabbath. As discussed above, such activation is beneficial for use with the household devices that are not equipped with specific instructions or may, on the other hand, be of the variety that is less sophisticated (as discussed above). In one example, the information the central node device relays implements the Sabbath mode remotely, i.e., causes operation of the less sophisticated devices to comply with the Sabbath rules.

As the disclosure mentions above, displaying a graphical use interface (e.g., at step 208) can solicit inputs and other information from an end user. The graphical interface can comprise any number of features, often determined in accordance with the display device and feature, e.g., found on the central node device and/or on a remote computing device (e.g., computer, laptop, smartphone, etc.). These features can convey information, e.g., display a picture of the household device to the end user and display operation information about energy usage. Moreover, the features can include selectable icons.

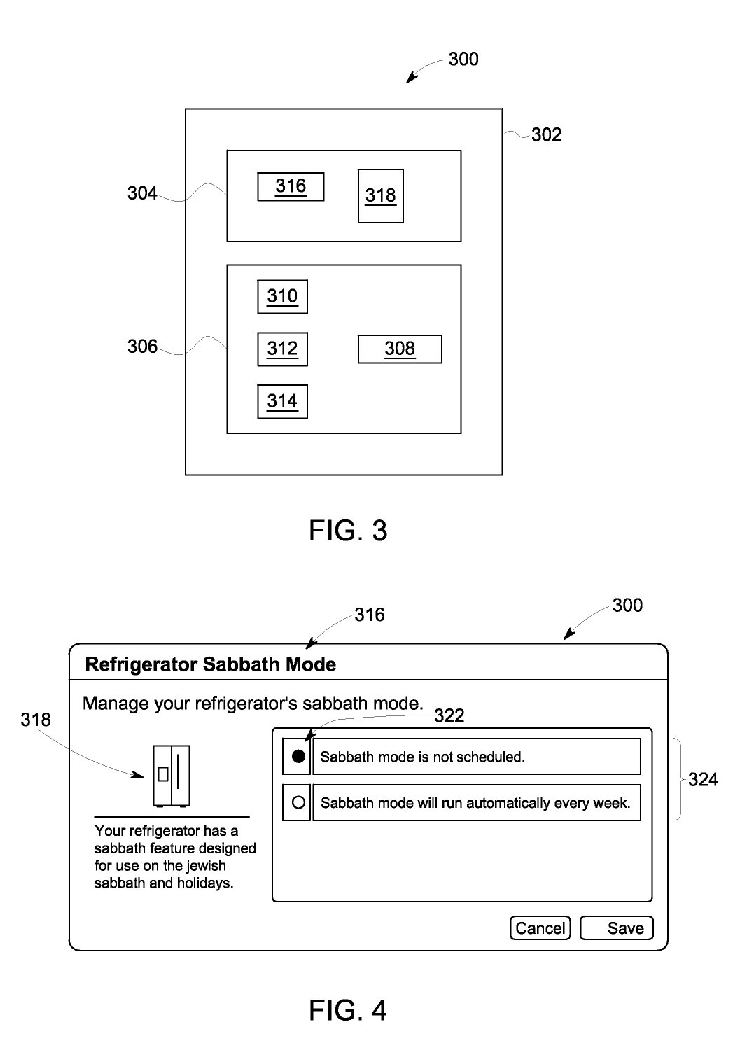

FIG. 3 illustrates an example of a graphical user interface 300 (also “interface 300”) for use with one or more computing devices. The interface 300 includes a display area 302 with one or more information components 304 and one or more input components 306. In one embodiment, the input components 306 can include a data field 308 and a plurality of selectable icons (e.g., a first selectable icon 310, a second selectable icon 312, and a third selectable icon 314).

Examples of the information components 304 convey information about the household device the end user is choosing to modify. The information components 304 can include a title field 316 and a picture field 318. The title field 316 displays a description (e.g., name) of the household device that is the subject of the display area 302. The picture field 318 is useful to provide an image (e.g., jpg, .tiff, etc.) of the household device to allow the end user visual confirmation of the household device.

Examples of the selectable icons 310, 312, 314 can include buttons, slides, and toggles the end user manipulates to convey the selected configuration for the Sabbath mode. At its simplest, the interface 300 could utilize a single button, for example, that allows the end user to enable and disable the Sabbath. This disclose also contemplates more complex examples of the interface 300, wherein the selectable icons 310, 312, 314 (and others if applicable) provide the end user with additional choices, combinations, and permutations of selects to program the selected configuration of the Sabbath mode.

FIG. 4 depicts a screenshot of the interface 300 that might appear on a display. In the example of FIG. 4, the title field 316 and the picture field 318 instruct the end user to select configurations for a refrigerator. The selectable icons take the form of illuminated and/or selectively fillable features 322 that identify, in the present example, one of two selected configurations 324 for the refrigerator. The end user can activate one of the selected configurations 324 by changing the selectively fillable features 322, e.g., from filled to unfilled, and vice versa.

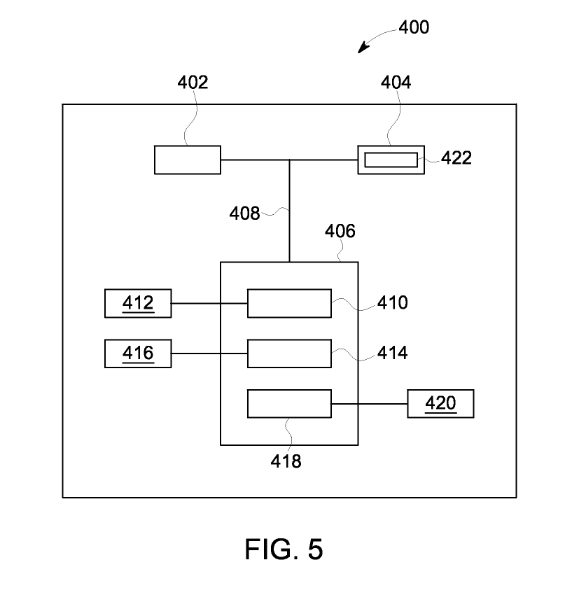

FIG. 5 depicts a schematic diagram that presents, at a high level, a wiring schematic for a central node device 400 that can operate a household device to implement Sabbath mode programming. The central node device 400 includes a processor 402, memory 404, and control circuitry 406. Busses 408 couple the components of the control device central node device 400 together to permit the exchange of signals, data, and information from one component of the central node device 400 to another. In one example, the control circuitry 406 includes port circuitry 410 which couples with a data port 412 (e.g., an Ethernet port, a USB port, etc.) and display circuitry 414 that couples with a display 416. The control circuitry 406 also includes a radio circuitry 418 that couples to a radio 420, e.g., a device that operates in accordance with one or more of the wireless protocols contemplated herein. As also shown in FIG. 5, memory 404 can include one or more software programs 422 in the form of software and/or firmware, each of which can comprise one or more executable instructions configured to be executed by the processor 402.

This configuration of components can dictate operation of the central node device 400 to manage operation of household devices. For example, the central control node 400 can provide signals (or inputs or outputs) through the data port 412 and/or the radio 418. These signals relate to information that can change operation of the household device to operate in the Sabbath mode.

The central control node 400 and its constructive components can communicate amongst themselves and/or with other circuits (and/or devices), which execute high-level logic functions, algorithms, as well as executable instructions (e.g., firmware instructions, software instructions, software programs, etc.). Exemplary circuits of this type include discrete elements such as resistors, transistors, diodes, switches, and capacitors. Examples of the processor 402 include microprocessors and other logic devices such as field programmable gate arrays (“FPGAs”) and application specific integrated circuits (“ASICs”). Although all of the discrete elements, circuits, and devices function individually in a manner that is generally understood by those artisans that have ordinary skill in the electrical arts, it is their combination and integration into functional electrical groups and circuits that generally provide for the concepts that are disclosed and described herein.

The structure of the components in the central control node 400 can permit certain determinations as to selected configuration and desired operating characteristics that an end user convey via the graphical user interface or that are retrieved or need to be retrieved by the device. For example, the electrical circuits of the central control node 400 can physically manifest theoretical analysis and logical operations and/or can replicate in physical form an algorithm, a comparative analysis, and/or a decisional logic tree, each of which operates to assign the output and/or a value to the output that correctly reflects one or more of the nature, content, and origin of the changes that occur and that are reflected by the inputs to the central control node 400 as provided by the corresponding control circuitry, e.g., in the control circuitry 406.

In one embodiment, the processor 402 is a central processing unit (CPU) such as an ASIC and/or an FPGA that is configured to instruct and/or control operation of the emitters 406. This processor can also include state machine circuitry or other suitable components capable of controlling operation of the components as described herein. The memory 404 includes volatile and non-volatile memory and can store executable instructions in the form of and/or including software (or firmware) instructions and configuration settings. Each of the control circuitry 406 can embody stand-alone devices such as solid-state devices. Examples of these devices can mount to substrates such as printed-circuit boards and semiconductors, which can accommodate various components including the processor 402, the memory 404, and other related circuitry to facilitate operation of the central control node 400.

However, although FIG. 5 shows the processor 402, the memory 404, and the components of the control circuitry 406 as discrete circuitry and combinations of discrete components, this need not be the case. For example, one or more of these components can comprise a single integrated circuit (IC) or other component. As another example, the processor 402 can include internal program memory such as RAM and/or ROM. Similarly, any one or more of functions of these components can be distributed across additional components (e.g., multiple processors or other components).

Moreover, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

As used herein, an element or function recited in the singular and proceeded with the word “a” or “an” should be understood as not excluding plural said elements or functions, unless such exclusion is explicitly recited. Furthermore, references to “one embodiment” of the claimed invention should not be interpreted as excluding the existence of additional embodiments that also incorporate the recited features.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A home energy management system comprising:
a household device; and
a central node device remotely located from the household device and configured to exchange a signal with the household device, the central node device comprising a processor, memory, and executable instructions stored on the memory and configured to be executed by the processor, the one or more executable instructions comprising executable instructions for generating the signal, wherein the signal encodes a selected configuration for operation of the household device in a Sabbath mode.

2. The system of claim 1, wherein the selected configuration causes the household device to enable the Sabbath mode.

3. The system of claim 1, wherein the selected configuration causes the household device to disable the Sabbath mode.

4. The system of claim 1, wherein the selected configuration causes the household device to execute the Sabbath mode after expiration of a prescribed time period.

5. The system of claim 1, wherein the selected configuration causes the household device to execute the Sabbath mode in accordance with a calendar entry.

6. The system of claim 6, wherein the central node device further comprises executable instructions for retrieving the calendar entry from a repository via a network connection.

7. The system of claim 1, wherein the central node device further comprises executable instructions for displaying a user interface with a selectable feature to solicit an input from an end user, wherein the input determines the selected configuration.

8. The system of claim 1, wherein the central node device further comprises executable instructions for operating one or more functions of the household device in accordance with the Sabbath mode.

9. The system of claim 1, wherein the household device comprises executable instructions for the Sabbath mode, and wherein the household device executes the executable instructions in response to the signal.

10. The system of claim 1, wherein the household device is part of a plurality of household devices that comprises a first household device and a second household device, wherein the first household device executes the Sabbath mode in response to the signal, and wherein the central node device further comprises executable instructions for operating one or more functions of the second household device in accordance with the Sabbath mode.

11. A method of controlling operation of a household device communicatively linked to but remote from a central node device comprising a processor and a memory, said method comprising:
receiving an input; and
generating a signal, in response to the input, that changes operation of the household device from a first mode to a second mode,
wherein the second mode instructs operation of one or more functions of the household device in accordance with observation of the Sabbath.

12. The method of claim 11, further comprising displaying a graphical user interface, wherein the graphical user interface comprises a selectable feature to solicit the input from an end user.

13. The method of claim 11, wherein the input comprises a calendar entry, and wherein the signal causes the household device to enter the second mode on a date associated with the calendar entry.

14. The method of claim 11, wherein the input defines a prescribed period of time to delay the change from the first mode to the second mode.

15. A device for use in a home energy management system, said device comprising:
a processor;
memory coupled to the processor; and
one or more executable instructions stored on the memory and configured to be executed by the processor, the one or more executable instructions comprising executable instructions for:
identifying from an input a selected configuration for a Sabbath mode on a household device; and
generating a signal that encodes the selected configuration for operation of the household device.

16. The device of claim 15, wherein the selected configuration causes the appliance to operate in the Sabbath mode.

17. The device of claim 15, wherein the selected configuration comprises a prescribed time period that delays operation of the appliance in the Sabbath mode.

18. The device of claim 15, wherein the input comprises a calendar entry, and wherein the selected configuration causes the appliance to operate in the Sabbath mode in accordance with the calendar entry.

19. The device of claim 18, further comprising executable instructions for retrieving data that relates to the calendar entry.

20. The device of claim 15, further comprising executable instructions for displaying a graphical user interface, wherein the graphical user interface comprises a selectable feature to solicit the input from an end user.
